(19) United States
(12) Patent Application Publication
(10) Pub. No.: US 2008/0100232 A1
(43) Pub. Date: May 1, 2008

(54) Power Supply Apparatus, Light Emitting Apparatus, and Display Apparatus

(76) Inventor: Mitsuaki Miguchi, Kyoto (JP)

Correspondence Address: CANTOR COLBURN, LLP, 20 Church Street, 22nd Floor, Hartford, CT, 06103, US

(21) Appl. No.: 11/883,016

(22) PCT Filed: Jan. 25, 2006
(86) PCT No.: PCT/JP06/01163

§ 371 Date: Jul. 25, 2007

(51) Int. Cl. H02M 3/137; H02M 3/155; H02J 3/14; H05B 39/04

(52) U.S. Cl. 315/294; 307/38; 307/31

(57) ABSTRACT

In the power supply apparatus, a voltage booster circuit supplies a drive voltage (Vout) to a plurality of light emitting diodes. A drive controller controls a driving state, that is, light emission intensity, of each of the plurality of light emitting diodes. The drive controller drives the plurality of load circuits in a time division manner, the voltage booster circuit is provided with an enabling terminal, and a switching operation is halted during a non-light-emission period in which none of the light emitting diodes is driven by the drive controller. A light emission pattern generator generates light emission control signals which direct light emission of each of the light emitting diodes. The voltage booster circuit halts a switching operation in a non-light-emission period in which none of the light emitting diodes emits light, by a logical operation on the light emission control signals.

### BACKGROUND OF THE INVENTION

1. Field of the Invention

The present invention relates in particular to a power supply apparatus that uses a switching power supply.

2. Description of the Related Art

In recent years, among small sized information terminals such as mobile telephones, PDAs (Personal Digital Assistants) and the like, devices are used that include those in which a voltage is required that is higher than an output voltage of a battery, as in, for example, a Light Emitting Diode (referred to as LED below) used as a backlight for liquid crystal panels, and the like. In many of these small sized information terminals, Li-ion batteries are used; the output voltage thereof is normally about 3.5 V, and, when fully charged, about 4.2 V, but the LED requires, as a drive voltage thereof, a voltage higher than the battery voltage. In this way, in cases in which a voltage higher than the battery voltage is required, the battery voltage is boosted using a voltage boosting type of switching power supply that uses a switching regulator, a charge pump circuit, or the like, and the voltage required to drive a load circuit, such as the LED or the like, is obtained.

By this type of switching apparatus, when an LED is driven, by connecting a constant current circuit on a drive system path of the LED, or by connecting a resistor and performing control so that voltage across the two ends of the resistor has a constant value, stabilization of the current value is realized so as to obtain a desired light emission intensity by keeping the current flowing in the LED constant (refer to Patent Document 1).

Patent Document 1: Japanese Patent Application, Laid Open No. 2004-22929

Here, in using an LED as a backlight of a liquid crystal panel, by connecting LEDs corresponding to respective RGB colors to a switching power supply and supplying a drive voltage, in addition to controlling current flowing in each of the LEDs, the respective RGB colors are emitted at a predetermined luminance, the colors are mixed, and white light is obtained. As a method of mixing the colors, there is a method of performing time division on three LEDs corresponding to the RGB, and turning them on alternately (below, referred to as a field sequential system).

In the field sequential system, in order to make each of the LEDs emit light at a desired luminance, it is necessary to supply a drive voltage to the LEDs connected as a plurality of load circuits, and furthermore it is necessary that a predetermined current flows in each of the LEDs. In this way, as in cases in which an LED is driven by the field sequential system, in cases in which a plurality of load circuits are time-divided and driven, in order to improve drive efficiency, there is a need to newly consider the driving method thereof. In particular, in a small sized information terminal driven by a battery, since implementing low power consumption affects operation time, the problem is serious.

### SUMMARY OF THE INVENTION

The present invention was made in light of these types of problems and has as a general purpose the provision of a power supply apparatus that can drive a plurality of load circuits at a high efficiency.

An embodiment of the present invention relates to a power supply apparatus. The power supply apparatus is provided with a switching power supply which supplies a drive voltage to a plurality of load circuits, and a drive controller which controls respective driving states of the plurality of load circuits. The drive controller drives the plurality of load circuits in a time division manner, and the switching power supply halts a switching operation during a period in which none of the load circuits are driven by the drive controller.

According to this embodiment, while the plurality of load circuits are driven in a time division manner, in a non-drive period in which none of the load circuits is driven, driving of the load circuits by the drive controller is halted, and in addition, by halting a switching operation of the switching power supply, power consumption through switching losses in the switching power supply can be curtailed, and high efficiency can be realized.

When halting the switching operation, the switching power supply may curtail or halt power supply to an internal circuit thereof. While the switching operation is curtailed or halted, by shutting off the power supply to the internal circuit, that is, the voltage or current supply, it is possible to realize further reduced power consumption. The “internal circuit” refers to a constant voltage supply, an oscillator, a switching element, or a driver circuit which drives a constant current source, used in a switching power supply.

The switching power supply may halt the switching operation based on a result of a logical operation on a signal that directs driving of each load circuit in the drive controller.

The drive controller may be connected to each of the plurality of load circuits, and may include a plurality of constant current circuits controlling the current. The switching power supply may halt the switching operation in a period in which all of the constant current circuits halt current generation.

The plurality of load circuits may be a plurality of light emitting elements.

The switching power supply may start the switching operation before the start of driving the plurality of load circuits. In this way, at the start of driving the load circuits, output voltage of the switching power supply can be stabilized, and it is possible to drive the load circuits more stably.

The plurality of load circuits may be a plurality of light emitting elements, and the switching power supply may start the switching operation before light emission start time so that the drive voltage supplied to the light emitting element reaches a predetermined drive voltage at the light emission start time. In this way, at the light emission start time of the light emitting element, the output voltage of the switching power supply applied to the light emitting elements can be stabilized, and the light emission can be done more stably.

The drive controller may direct the start of driving in each of the load circuits based on a signal for which a predetermined delay is given to a signal directing the start of the switching operation of the switching power supply.

An other embodiment of the present invention is a light emitting apparatus. The light emitting apparatus includes the abovementioned power supply apparatus, and a plurality of light emitting elements driven by the power supply apparatus.

According to this embodiment, it is possible to realize low power consumption in the light emitting apparatus.

An other embodiment of the present invention is a display apparatus. The display apparatus is provided with a plurality of light emitting elements driven by the power supply apparatus, and a display panel including a liquid crystal panel operating with the light emitting elements as a backlight. The switching power supply of the power supply apparatus halts the switching operation when the liquid crystal panel is in a light blocking state.

According to this embodiment, when the liquid crystal panel is in the light blocking state with a black display, since the backlight is turned off, it is possible to realize low power consumption in the display apparatus. In addition, by turning off the backlight, it is possible to have a more truly black display.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram showing a configuration of a light emitting apparatus according to a first embodiment;

FIG. 2 is a circuit diagram showing a configuration of a constant current circuit and switches of FIG. 1;

FIG. 3 is a time chart showing an operation state of the light emitting apparatus of FIG. 1;

FIG. 4 is a circuit diagram showing a configuration of a light emitting apparatus according to a second embodiment;

FIG. 5 is a time chart showing an operation state of the light emitting apparatus of FIG. 4;

FIG. 6 is a time chart showing an operation state of the light emitting apparatus of FIG. 4; and

FIG. 7 is a circuit diagram showing a modified example of a luminance adjustment PWM oscillator.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

### First Embodiment

First, an explanation is given of an outline of a power supply apparatus according to a first embodiment of the present invention. The power supply apparatus is an LED drive circuit for driving LEDs corresponding to three colors RGB, used as a backlight of a liquid crystal panel. The LED drive circuit boosts battery voltage outputted from a battery to voltage necessary to drive the LEDs, and also controls current flowing in each LED to make the LEDs emit light at a desired luminance. The LED drive circuit performs time division on each LED by a field sequential system, to emit light.

Below, an explanation is given concerning a configuration of the power supply apparatus according to the present embodiment.

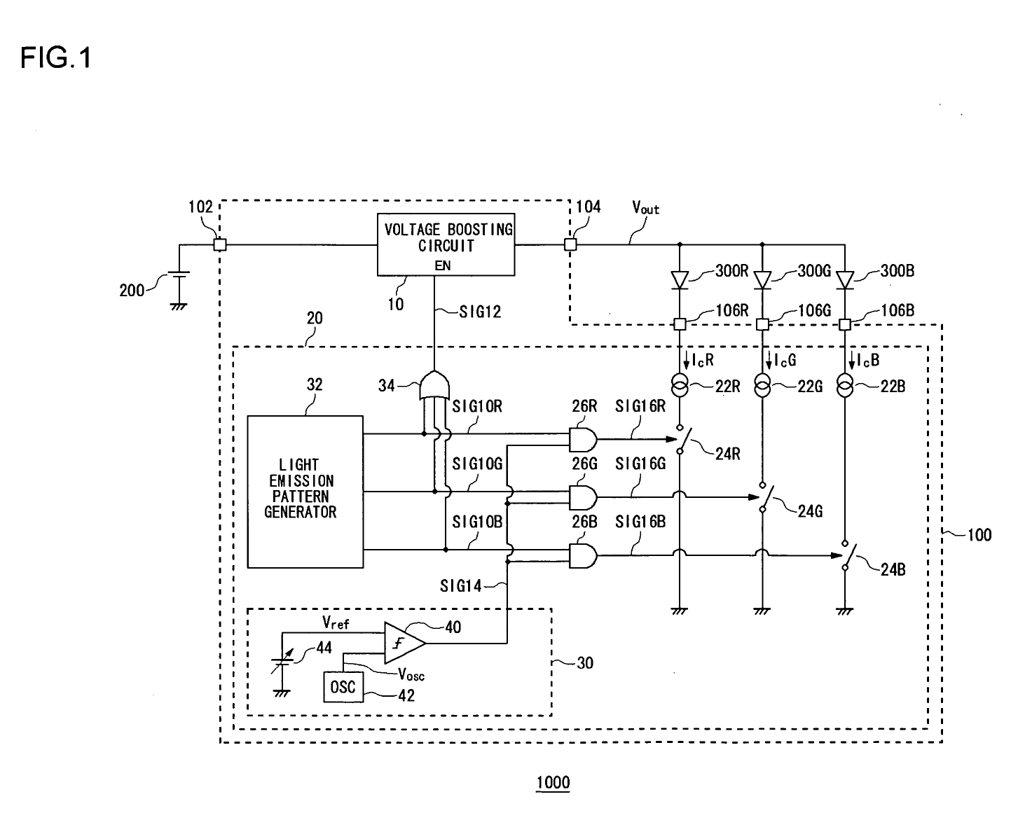

FIG. 1 is a circuit diagram showing a configuration of a light emitting apparatus 1000 according to a first embodiment. The light emitting apparatus 1000 includes light emitting diodes 300R to 300B that are light emitting elements, and a power supply apparatus 100 for driving the light emitting diodes 300R to 300B. The light emitting apparatus 1000 is installed in an information terminal driven by a battery 200, and the power supply apparatus 100 boosts battery voltage Vbat outputted from a battery 200, to generate a drive voltage Vout necessary to drive the light emitting diodes 300R to 300B. Below, where there is no particular need to distinguish between respective colors, letters R, G, and B, that are attached to respective component elements corresponding to each color, are omitted.

The power supply apparatus 100 includes, as input and output terminals, an input terminal 102 to which the battery voltage Vbat is inputted, an output terminal 104, and LED terminals 106. The output terminal 104 is connected to anode terminals of the light emitting diodes 300, and outputs the output voltage Vout obtained by boosting the battery voltage Vbat. The LED terminals 106 are connected to cathode terminals of the light emitting diodes 300.

The power supply apparatus 100 includes a voltage booster circuit 10 and a drive controller 20. The voltage booster circuit 10 boosts the battery voltage Vbat inputted from the input terminal 102, and outputs the output voltage Vout from the output terminal 104. The voltage booster circuit 10 is configured as a switching power supply including a switching element such as a switching regulator, a charge pump circuit, or the like. The voltage booster circuit 10 is provided with an enabling terminal EN; when an enabling signal SIG12 inputted to the enabling terminal EN has a high level, a switching operation is performed to boost the battery voltage Vbat, and when at a low level, the switching operation is halted.

The drive controller 20 controls respective driving states of the light emitting diodes 300R to 300B. The drive controller 20 includes constant current circuits 22R to 22B, switches 24R to 24B, AND gates 26R to 26B, a luminance adjustment PWM oscillator 30, a light emission pattern generator 32, and an OR gate 34.

The light emission pattern generator 32 controls emission and halting of light of each of the light emitting diodes 300R to 300B, based on data stored in memory or data inputted from outside. The light emission pattern generator 32 generates light emission control signals SIG10R to SIG10B corresponding to each color. When a light emission control signal SIG10 has a high level, a corresponding light emitting diode 300 emits light, and when it has a low level, the light emitting diode 300 halts light emission. In the light emitting apparatus 1000 according to the present embodiment, since each of the light emitting diodes 300R to 300B is time divided and made to emit light alternately in an order of R, G, and B, the light emission control signals SIG10R, SIG10G, and SIG10B are set, in order, to a high level. The respective light emission control signals SIG10R to SIG10B go to a high level every 210 Hz, and light emitting diodes 300 of the same color turn on at a cycle of 70 Hz.

Constant current circuits 22 are connected to the cathode terminals of the light emitting diodes 300 via the LED terminals 106, and are arranged on a current path of each of the light emitting diodes 300R to 300B. The constant current circuits 22 generate constant currents IcR to IcB corresponding to light emission intensity of each of the light emitting diodes 300, and control current flowing in each of the light emitting diodes 300. That is, when the constant currents IcR to IcB are large, each of the light emitting diodes 300R to 300B emits light at a high intensity. The current values of each of the constant currents IcR to IcB are determined for every respective color by a current controller not shown in the figures.

The switches 24 turn the current generation ON or OFF, by the respective constant current circuits 22. When the switches 24 are ON, the constant current circuits 22 generate a constant current Ic, and constant current flows in the connected light emitting diodes 300, and when the switches 24 are OFF, the constant current circuits 22 halt generation of the constant current Ic, and light emission of the connected light emitting diodes 300 is halted. Turning the switches 240N or OFF is controlled by output signals SIG16 of the AND gates 26; when the signals have high levels, the switches are ON and when the signals have a low level, the switches are OFF.

In FIG. 1, the switches 24 are arranged on current paths of the light emitting diodes 300, but if current generation can be halted, the switches 24 may be arranged at other positions.

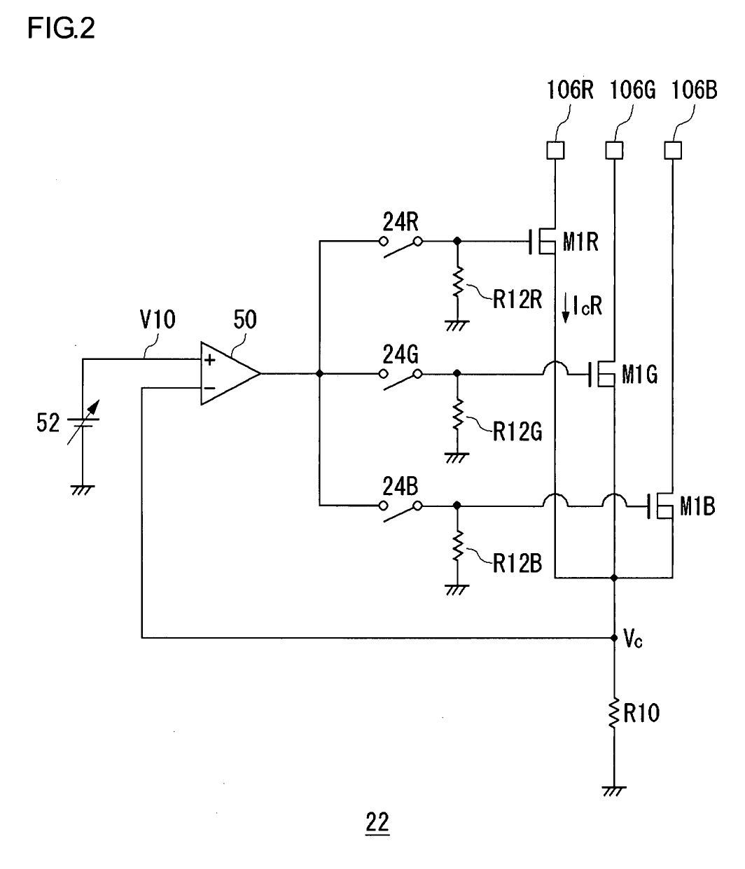

FIG. 2 is a circuit diagram showing another configuration of a constant current circuit 22 and switches 24. In the constant current circuit, different to FIG. 1, the switches are not arranged on the current paths, and are connected to control terminals of transistors constituting the constant current circuits.

The constant current circuit of FIG. 2 includes transistors M1R to M1B connected respectively to each of the light emitting diodes 300R to 300B, a resistor R10, an operational amplifier 50, a reference voltage source 52, the switches 24R to 24B, and pull-down resistors R12R to R12B. The constant current circuit 22 is configured using the resistor R10 and the operational amplifier 50 shared by the constant current circuits 22R to 22B of FIG. 1.

The transistors M1 are N-MOSFETs, drain terminals are connected to the LED terminals 106, and source terminals are grounded via the resistor R10. The voltage of the source terminals of the transistors M1 is fed-back to an inverse input terminal of the operational amplifier 50.

The reference voltage source 52 generates a reference voltage V10 different for each color, and outputs to a non-inverse input terminal of the operational amplifier 50. Output of the operational amplifier 50 is applied to gate terminals of the transistors M1 via the switches 24.

Operation of the constant current circuit 22 when the switch 24R is turned ON is now explained.

When the constant current circuit 22 operates as the constant current circuit 22R that generates current flowing as the constant current IcR in the light emitting diode 300R connected to the LED terminal 106R, the reference voltage source 52 generates the reference voltage V10R. When the switch 24R is ON, the transistor M1R is ON by output of the operational amplifier 50, and the current IcR flows in the transistor M1R. By the current IcR flowing in the resistor R10, voltage Vc=IcR×R10 occurs across the resistor R10. Output of the operational amplifier 50, that is, a gate voltage of the transistor M1R, is fed back so that the reference voltage V10R applied to the non-inverse input terminal and the voltage Vc fed back from the resistor R10 become equal. As a result, V10R=IcR×R10 holds true, the current flowing in the transistor M1R becomes IcR=V10R/R10, and the light emitting diode 300R is driven with a constant current.

When the switch 24R is OFF, the gate terminal of the transistor M1R is grounded by the pull-down resistance R12R, and the transistor M1R is turned OFF, so that the constant current IcR=0, and generation of the constant current is halted.

In the same way, generation of the constant current IcG is controlled by the switch 24G being ON or OFF, and generation of the constant current IcB is controlled by the switch 24B.

The explanation returns to FIG. 1. The luminance adjustment PWM oscillator 30 generates a PWM signal SIG14 for turning the switches 240N and OFF. For the PWM signal SIG14, a voltage comparator 40, an oscillator 42, and a reference voltage source 44 are included. The reference voltage source 44 generates a reference voltage Vref corresponding to each RGB color. The oscillator 42 generates a cyclic voltage Vosc of a triangular waveform or a sawtooth waveform. Oscillation frequency of the oscillator 42 is set sufficiently higher than the frequency of the abovementioned light emission control signals SIG10R to SIG10B. The voltage comparator 40 compares the reference voltage Vref outputted from the reference voltage source 44 and the cyclic voltage Vosc, and outputs the PWM signal SIG14 for which high level and low level periods change in accordance with a magnitude correlation thereof. The PWM signal SIG14 controls light emission intensities of the light emitting diodes 300 in accordance with a duty ratio thereof.

The light emission control signals SIG10 outputted from the light emission pattern generator 32 and the PWM signal SIG14 outputted from the luminance adjustment PWM oscillator 30 are inputted to the AND gates 26. The AND gates 26 output logical products of the two input signals as output signals SIG16. The output signals SIG16 of the AND gates 26 have a high level when both the light emission control signals SIG10 and the PWM signal SIG14 have a high level.

The light emission control signals SIG10R to SIG10B outputted from the light emission pattern generator 32 are inputted to the OR gate 34. The OR gate 34 outputs a logical sum of the three signals to the enabling terminal EN of the voltage booster circuit 10.

An explanation will be given concerning operation of the light emitting apparatus 1000 configured as above.

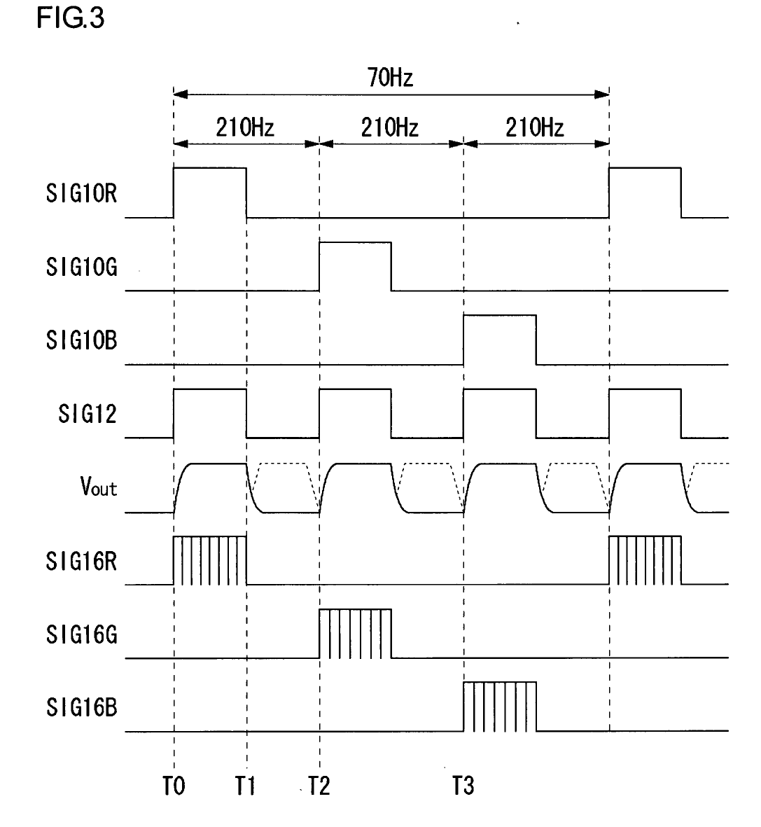

FIG. 3 is a time chart showing an operation state of the light emitting apparatus 1000. The light emission control signals SIG10R, SIG10G, and SIG10B generated by the light emission pattern generator 32 respectively repeat a high level and a low level at a cycle of 70 Hz. Furthermore, the respective light emission control signals SIG10R to SIG10B go to a high level, in order, at a cycle of 210 Hz.

The enabling signal SIG12 goes to a high level when any of the light emission control signals SIG10R to SIG10B has a high level.

When the light emission control signal SIG10R that directs light emission of the red color light emitting diode 300R at time T0 goes to a high level, since the enabling signal SIG12 inputted to the enabling terminal of the voltage booster circuit 10 also goes to a high level, the voltage booster circuit 10 starts a switching operation, that is, voltage boosting of the battery voltage Vbat, and the output voltage Vout increases.

By the PWM signal SIG14, which is pulse-width modulated, being outputted from the luminance adjustment PWM oscillator 30, and the light emission control signal SIG10R going to a high level, the switch 24R intermittently turns current flowing in the light emitting diode 300R ON and OFF based on a duty ratio of the PWM signal SIG14. Consequently, in the period from time T0 to T1, the light emitting diode 300R emits light of a predetermined luminance based on the PWM signal SIG14 and the constant current IcR.

When the light emission control signal SIG10R goes to a low level at time T1, the switching signal SIG16R also goes to a low level. When the switch 24R is in an OFF state, since current does not flow in the light emitting diodes 300R, light emission halts.

In a period from time T1 to time T2, since all of the light emission control signals SIG10R to SIG10B have a low level, the enabling signal SIG12 inputted to the voltage booster circuit 10 also goes to a low level, the switching operation is halted, and a voltage boosting operation is halted. During this period, by each circuit block inside the voltage booster circuit 10 shutting off each current path, a low current consumption mode exists. Furthermore, a broken line in this period indicates that the output voltage Vout is unstable.

At time T2, when the light emission control signal SIG10G goes to a high level, the enabling signal SIG12 of the voltage booster circuit 10 also goes to a high level, each circuit block that has a low current consumption mode returns to an operation state, and the voltage boosting operation is again started. As a result, soon after time T2, the output voltage Vout of the voltage booster circuit 10 stabilizes. At time T2, the green color light emitting diode 300G starts light emission.

In this way, in the light emitting apparatus 1000 according to the present embodiment, the light emitting diodes 300 alternately emit light in a time divided manner, and between light emission periods of each of the light emitting diodes 300, a non-light-emission period is arranged, in which none of the light emitting diodes 300 emit light. By the voltage booster circuit 10 shutting off current supply and voltage supply to internal circuit blocks in this non-light-emission period, it is possible to reduce power consumption of the voltage booster circuit 10, and it is possible to drive the light emitting diodes 300 at a high efficiency. As a result, it is possible to extend the life of the battery 200. As a result, it is possible to extend operation time of a set in which the light emitting apparatus 1000 is installed. Furthermore, by shutting off the current and voltage supply of the internal circuit blocks, it is possible to curtail heat generation.

### Second Embodiment

A light emitting apparatus according to a second embodiment, similar to the first embodiment, also includes light emitting diodes 300 used as a background light of a liquid crystal panel. The light emitting apparatus according to the present embodiment causes the light emitting diodes 300R to 300B to emit light more stably at a desired luminance.

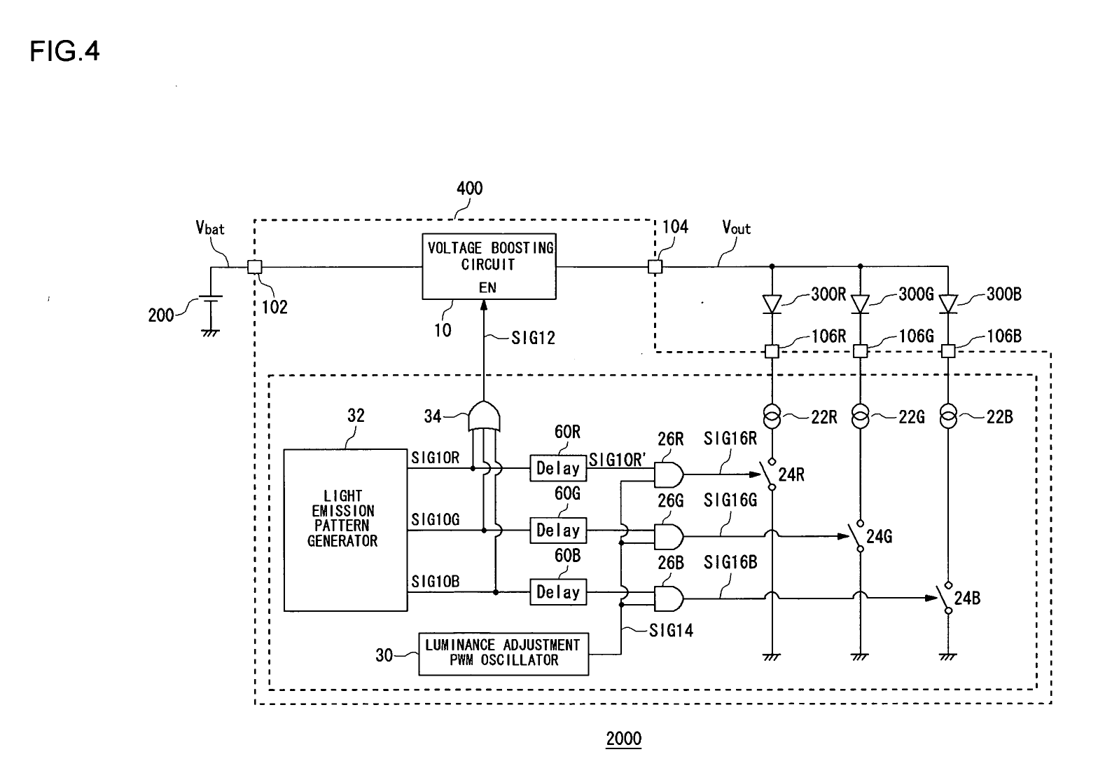

FIG. 4 is a circuit diagram showing a configuration of the light emitting apparatus 2000 according to the present embodiment. In FIG. 4, component elements that are the same as or equivalent to those in FIG. 1 are given the same reference symbols, and explanations are omitted as appropriate. The light emitting apparatus 2000 includes the light emitting diodes 300R to 300B and a power supply apparatus 400.

The power supply apparatus 400 is further provided with delay circuits 60R to 60B, added to the power supply apparatus 100 of FIG. 1. The delay circuits 60R to 60B respectively delay the light emission control signals SIG10R to SIG10B generated by the light emission pattern generator 32, and output to the AND gates 26R to 26B. Delay time in the delay circuits 60 is τ.

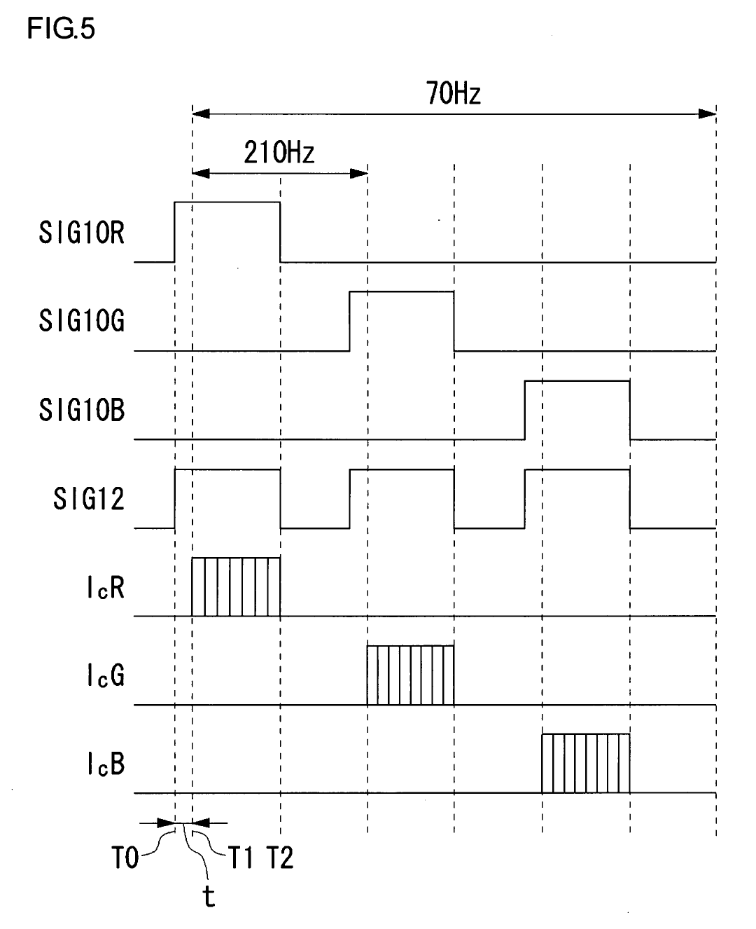

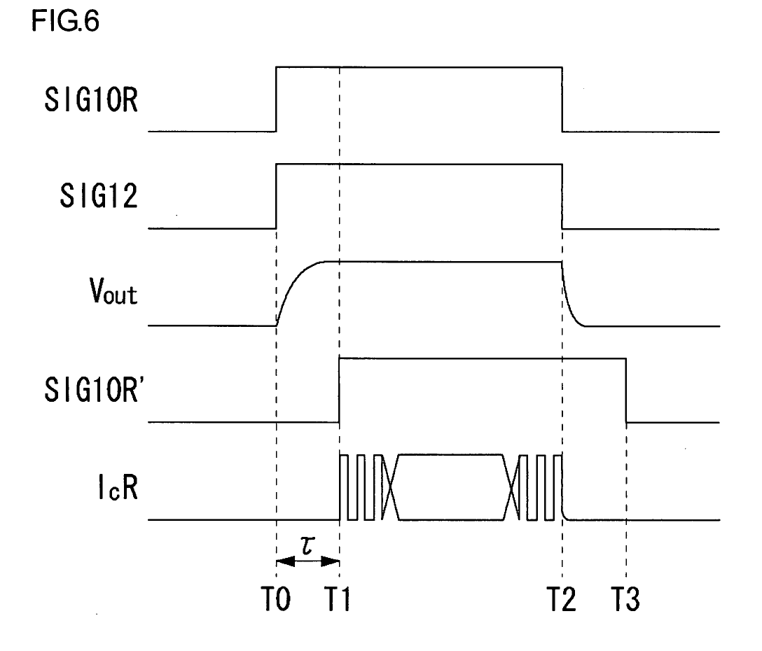

An explanation will be given concerning operation of the light emitting apparatus 2000 configured as above. FIG. 5 is a time chart showing an operation state of the light emitting apparatus 2000. Furthermore, FIG. 6 is an enlarged illustration of the time chart of FIG. 5.

The light emission control signals SIG10R, SIG10G, and SIG10B, generated by the light emission pattern generator 32 respectively repeat a high level and a low level at a cycle of 70 Hz. Furthermore, each of the light emission control signals SIG10R to SIG10B goes to a high level, in order, at a cycle of 210 Hz. Periods in which the respective light emission control signals SIG10R to SIG10B have a high level are set to be longer than periods shown in the time chart of FIG. 3. At time T0, the light emission control signal SIG10R goes to a high level, and at time T1, at which a time τ has elapsed from time T0, the switch 24R starts ON and OFF operations, and generation of the constant current IcR starts.

As shown in FIG. 6, when the light emission control signal SIG10R goes to a high level at time T0, the enabling signal SIG12 of the voltage booster circuit 10 also goes to a high level, and a voltage boosting operation starts. When the voltage booster circuit 10 starts, the output voltage Vout increases, and at time T1 after time τ has elapsed, the output voltage Vout has a stable value.

At the time T1 at which the output voltage Vout has stabilized, a signal SIG10R′ inputted to the AND gate 26R goes to a high level, and generation of the constant current IcR by the constant current circuit 22R starts. At this time, since the output voltage Vout is stably applied to the anode terminal of the light emitting diode 300R, it is possible to emit light at a desired luminance. When the light emission control signal SIG10R goes to a low level at time T2, since the output voltage Vout of the voltage booster circuit 10 decreases, a drive voltage is not applied to the light emitting diode 300R, the constant current IcR does not flow, and light emission of the light emitting diode 300R halts. After that, at time T3 the output signal SIG10R′ of the delay circuit 60 goes to a low level.

As shown in FIG. 3, in the light emitting apparatus according to the first embodiment, since the generation of the constant current IcR is started at the same time as the start of the voltage boosting operation of the voltage booster circuit 10, in cases in which time is required for stabilizing of the output voltage Vout, or in cases in which a switching cycle of the light emitting diodes 300 is short, the desired light emission luminance may not be obtained.

In the light emitting apparatus 2000 according to the second embodiment, in order to solve this problem, the voltage boosting operation of the voltage booster circuit 10 is started before generation of a constant current by the constant current circuits 22, and since the light emitting diodes 300 are driven with a constant current after the output voltage Vout has stabilized, it is possible to emit light at a more accurate luminance.

In this way, according to the power supply apparatus 400 according to the present embodiment, similar to the first embodiment, since the switching operation of the voltage booster circuit 10 is halted during a non-light-emission period of the light emitting diodes 300, it is possible to improve efficiency. Furthermore, by starting the voltage boosting operation before starting light emission operation of the light emitting diodes 300, during a light emission period of the light emitting diodes 300 it is possible to stably supply voltage necessary for driving the light emitting diodes 300, so that light can be emitted at a more stable luminance.

The abovementioned embodiments are examples; various modified examples in combinations of various component elements and various processes thereof are possible, and a person skilled in the art will understand that such modified examples are within the scope of the present invention.

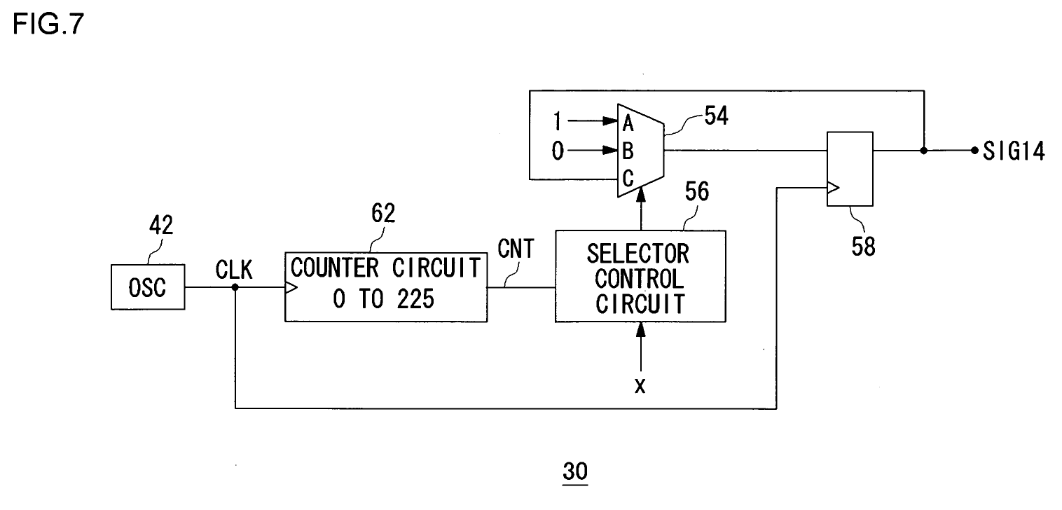

In the embodiments, explanations have been given concerning cases in which the luminance adjustment PWM oscillator 30 is configured using an analog circuit, but the configuration may also be as shown in FIG. 7. FIG. 7 shows a modified example of a luminance adjustment PWM oscillator.

The luminance adjustment PWM oscillator 30 includes an oscillator 42, a counter circuit 62, a selector 54, a selector control circuit 56, and a latch circuit 58. The oscillator 42 generates a clock signal CLK, and outputs to the counter circuit 62. The counter circuit 62 counts the clock signal CLK outputted from the oscillator 42, and outputs a count value CNT to the selector control circuit 56.

The selector 54 is provided with three input terminals A to C. The selector control circuit 56 controls an output signal of the selector 54. The output signal from the selector 54 is inputted to the latch circuit 58. Output of the latch circuit 58 is outputted as the PWM signal SIG14. The PWM signal SIG14 is inputted, together with digital values 0 and 1, to the input terminals A to C of the selector 54.

A luminance adjustment signal x is inputted from outside to the selector control circuit 56. This luminance adjustment signal x has a value of 0 to 255. The selector control circuit 56 compares the count value CNT and the luminance adjustment signal x. As a result of the comparison, the selector control circuit 56 chooses the A terminal of the selector 54 when CNT=0, chooses the B terminal of the selector 54 when CNT=x, and chooses the C terminal otherwise. As a result, output of the selector 54 has a high level while the counter value is from 0 to x, and has a low level while the counter value is from x to 255.

In cases in which the luminance adjustment PWM oscillator 30 is configured in this way by a digital circuit, accuracy of pulse width modulation, and particularly linearity, can be improved.

In the embodiments, an explanation has been given concerning cases in which the load circuits of the power supply apparatus are light emitting diodes, but there is no limitation thereto, and besides this, the present invention can be applied also to cases in which a plurality of load circuits is driven in a time division manner; by halting a switching operation of the voltage booster circuit in a period in which none of the load circuits is operating, it is possible to realize improved efficiency. Furthermore, the light emitting diodes are not limited to the three colors RGB, and a light emitting diode of four colors, with emerald (bluish green) added to the three colors RGB, is also possible.

Moreover, in the embodiments, explanations have been given concerning cases in which the voltage booster circuit is used as a switching power supply; however, also in cases in which other switching power supplies are used, such as a step down switching regulator or a charge pump circuit, a voltage inversion charge pump circuit, and the like, low power consumption can be realized by application of the abovementioned technology. A clock signal for controlling a switching element of the switching power supply may be generated internally in the switching power supply; a clock of the oscillator 42 may also be used; and besides these, a clock inputted from outside may also be used.

In the embodiments the transistors used were FETs, but other types of transistors, such as a bipolar transistor or the like, may be used, and selection thereof may be decided according to design specification required by the power supply apparatus, by semiconductor manufacturing process used, or the like.

In the present embodiments, all of the elements of which the power supply apparatus is configured may be integrated in one unit, or may be configured to be divided among a plurality of integrated circuits. In addition, the embodiments may have a portion thereof configured as discrete parts. Decisions as to which part is integrated may be taken in accordance with cost, space occupied, and the like.

While the preferred embodiments of the present invention have been described using specific terms, such description is for illustrative purposes only, and it is to be understood that changes and variations may be made without departing from the spirit or scope of the appended claims.

1. A power supply apparatus comprising:
a switching power supply which supplies a drive voltage to a plurality of load circuits; and
a drive controller which controls respective driving states of the plurality of load circuits; wherein
the drive controller drives the plurality of load circuits in a time division manner, and the switching power supply halts a switching operation during a period in which none of the load circuits is driven by the drive controller.

2. A power supply apparatus according to claim 1, wherein the switching power supply halts a switching operation based on a result of a logical operation on signals that direct driving of the plurality of load circuits by the drive controller.

3. A power supply apparatus according to claim 1, wherein the switching power supply, when halting a switching operation, curtails power supply to an internal circuit thereof.

4. A power supply apparatus according to claim 1, wherein the drive controller is connected to each of the plurality of load circuits, and includes a plurality of constant current circuits that control current; and
the switching power supply halts a switching operation in a period in which all of the constant current circuits halt current generation.

5. A power supply apparatus according to claim 1, wherein the plurality of load circuits is a plurality of light emitting elements.

6. A power supply apparatus according to claim 1, wherein the switching power supply starts a switching operation before starting driving the plurality of load circuits.

7. A power supply apparatus according to claim 6, wherein the plurality of load circuits is a plurality of light emitting elements; and
the switching power supply starts a switching operation before light emission start time so that the drive voltage supplied to the light emitting elements, which are the load circuits, reaches a predetermined drive voltage at the light emission start time.

8. A power supply apparatus according to claim 6, wherein the drive controller directs starting of driving in each of the load circuits based on a signal for which a predetermined delay is given to a signal directing starting of a switching operation of the switching power supply.

9. A light emitting apparatus comprising:
a power supply apparatus according to claim 1; and
a plurality of light emitting elements which are driven by the power supply apparatus.

10. A light emitting apparatus comprising:
a power supply apparatus according to claim 1;
a plurality of light emitting elements which are driven by the power supply apparatus; and
a display panel including a liquid crystal panel in which the light emitting elements are operated as a backlight; wherein
the switching power supply of the power supply apparatus halts a switching operation when the liquid crystal panel is in a light blocking state.
